(19) United States
(12) Patent Application Publication
(10) Pub. No.: US 2025/0360558 A1
(43) Pub. Date: Nov. 27, 2025

(54) METHOD FOR MANUFACTURING A PART BASED ON MULTIPLE PRECIOUS METALS, AND RESULTING PART

(71) Applicants: MANUFACTURE D'HORLOGERIE AUDEMARS PIGUET SA, Le Brassus (CH); NORIMAT SAS, Toulouse (FR)

(72) Inventors: Sandra GUADALUPE MALDONADO, Romainmôtier (CH); Thibaut LE LOARER, Chavannaz (FR); Romain EPHERRE, Toulouse (FR); Bastien NODENOT, Toulouse (FR); Yannick BEYNET, Toulouse (FR)

(73) Assignees: MANUFACTURE D'HORLOGERIE AUDEMARS PIGUET SA, Le Brassus (CH); NORIMAT SAS, Toulouse (FR)

(21) Appl. No.: 18/874,969

(22) PCT Filed: Jun. 14, 2023
(86) PCT No.: PCT/IB2023/056127

§ 371 Date: Dec. 13, 2024

(30) Foreign Application Priority Data
Jun. 15, 2022 (EP) 22179302.9

(51) Int. Cl. B22F 7/02; B22F 3/00; B22F 3/14; B22F 3/24; B22F 7/00; B22F 9/08; G04D 3/00

(52) U.S. Cl. CPC B22F 7/02; B22F 3/004; B22F 3/14; B22F 3/24; B22F 7/008; B22F 9/082; G04D 3/0069; B22F 2003/247; B22F 2301/25; B22F 2998/10

(57) ABSTRACT

The present invention relates to a process for manufacturing a mechanical part based on at least two precious or noble metals or alloys thereof, the process comprising a step of atomizing the various precious metals, positioning the resulting powders in a mold so as to form an assembly of unmixed powders, and a step of sintering at temperatures below the melting temperatures of the metals used. The invention also covers a mechanical part produced by such a process, as well as a timepiece comprising such a mechanical part.

### TECHNICAL FIELD

The present invention concerns a process for manufacturing a watch component based on several precious or noble metals or alloys of such metals, which are individually atomized into separate powders before being jointly involved in a sintering operation, in particular SPS (spark plasma sintering) also known as flash sintering. The various precious or noble metals can be distinguished from one another in the resulting watch component. The present description also covers a watch component made of several distinct precious metals, as well as a timepiece comprising such a component.

### PRIOR ART

The principle of sintering powders of metallic materials is known and often used to manufacture metal alloys. The document EP3766997, for example, describes the formation of precious metal alloys using such a process. However, such alloys require the powders to be homogenized or at least mixed. Such processes cannot produce components with local compositions that differ from one another.

Document EP3822712 gives an example of a process using metal powders to design a component for a timepiece. The metals involved in the process are not limited to precious or noble metals and include, for example, stainless steel or aluminum. Sintering conditions are therefore not suitable for the production of components made of precious metals, which are distributed separately in the final part.

The document EP 2728422 describes the manufacture of a bimetallic component comprising a base to which a cover plate is welded. This process requires at least partial melting of the metals involved. This process is further constrained by the use of metal plates, which limits the diversity of effects obtained.

The document CH715336 focuses on the production of two-color components in which the demarcation between the colors is clear. To achieve this, subassemblies of amorphous materials in different colors must be produced separately and then assembled under stress. This process requires meticulous machining operations to assemble the sub-assemblies, as well as joining elements that act as ornaments.

The sintering technique is an alternative to brazing or welding, which has the advantage of limiting or avoiding the addition of material at interfaces, as well as mixing the materials involved. It also enables monolithic parts to be produced. However, this process is not yet popular for precious metals. There is therefore a room for developing a process specifically adapted to precious materials, enabling a wider variety of uses and assemblies.

### BRIEF SUMMARY OF THE INVENTION

One aim of the present invention is to propose a process specifically adapted to precious metals and their alloys, making it possible to manufacture a metal part, such as a watch component, whose various metals are distinct from one another. In particular, the process of the present description proposes to assemble different precious metals without mixing them. In addition, the present process proposes to avoid locally modifying the compositions during the production of the part.

Another aim of the invention is to produce a monolithic or monobloc mechanical part, in particular a watch component, comprising or consisting of two or more precious metals or precious metal alloys, which are distinct from one another. In particular, such a mechanical part or watch component preferably has no or a minimal concentration gradient of the various constituents at their interfaces, for example over a thickness of less than 10 micrometers, or less than 5 micrometers or less than 1 micrometer. The terms “monolithic” or “monobloc” are used to designate a part made up of a single block, i.e. it is not the result of an assembly of prefabricated subassemblies.

According to the invention, these aims are achieved in particular by means of the process and the component which are the subject of the independent claims, and the details of which are the subject of the dependent claims.

In particular, this solution offers the advantage over the prior art of producing precious-metal-based watch components with a particular aesthetic appearance and/or mechanical properties due to the localized distribution of the various metals of which they are composed. In particular, local variations in color and/or hardness can be produced directly in the mass of the component and without additional steps. In particular, the parts produced in this way are monobloc, making them more resistant and/or simpler to produce.

### BRIEF DESCRIPTION OF THE DRAWINGS

Examples of implementation of the invention are shown in the description illustrated by the following figures:

FIG. 1: Process according to one embodiment of the present invention.

FIG. 2: Process according to another embodiment of the present invention.

FIG. 3: Schematic representation of post-demolding steps that may be involved in the process according to the present invention.

### DETAILED DESCRIPTION OF THE INVENTION

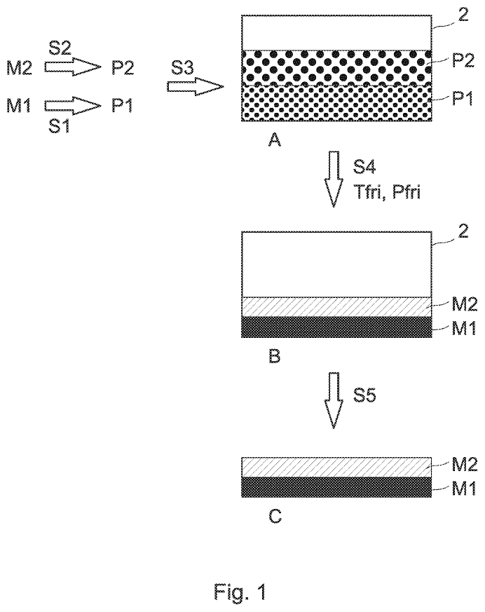

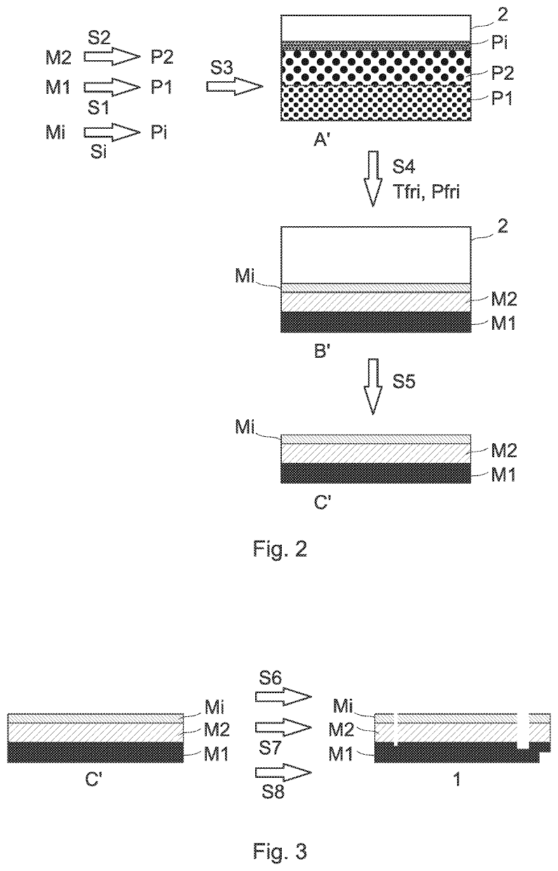

The process described herein is illustrated in FIGS. 1 and 2. In a first step S1, one of the materials M1 constituting the mechanical part is atomized into a first powder P1. In the present description, the term “atomizing” refers to any suitable operation for reducing the considered material to a powder. This may consist of or include a grinding step. The obtained powder may be made up of particles of varying fineness. For example, the particles are micrometric in size, with an average diameter in the range 1 μm to 500 μm, or 10 to 100 μm. Alternatively, the particles may be sub-micrometric, i.e. with an average diameter of less than one micrometer

The average particle size of the powder can be adapted according to the material and/or the result to be obtained.

The process includes a step S2 for atomizing a second material M2 to produce a second powder P2. The atomization conditions may be identical to or different from those for atomizing the first material M1. The average particle size forming the second powder P2 may be identical or similar to that forming the first powder P1. Alternatively, different particle sizes can form the first P1 and second P2 powders. It is understood that the atomization steps of the first M1 and second M2 materials are carried out separately from each other, so that distinct powders P1, P2 are obtained. In particular, the process according to the present invention does not include any mixing step of these first P1 and second P2 powders. More particularly, the process according to the present invention includes all provisions for not mixing the first P1 and second P2 powders. It may even be provided that the first M1 and second M2 materials are atomized in different locations so as to avoid or limit contamination from one to the other. A device for tracing or tracking the different materials and powders can also be provided. According to these arrangements, the process can include steps for separate packaging, tracing and separate storage of materials and/or powders.

The atomization step for the first material M1 can be carried out in parallel with that for the second material M2, or sequentially.

According to one embodiment, one or more of the materials used in the present process can be selected directly in powder form, so that the corresponding atomization steps S1, S2, Si described herein are not necessary.

The first M1 and second M2 materials are both selected from precious or noble metals, or alloys based on such precious or noble metals.

Precious or noble metals according to the present description include gold (Au), silver (Ag), platinum (Pt), palladium (Pd), rhodium (Rh), scandium (Sc), ruthenium (Ru), osmium (Os) and iridium (Ir). In particular, noble metals refer to corrosion-resistant metals. In the context of the present description, the terms “precious” and “noble” are interchangeable and equivalent, so that either of these terms designates the metals listed above.

In the context of the present description, alloys of these precious metals comprise at least 50% by mass, or 80% or more, or even 95% by mass of one of these precious metals or a combination of these precious metals. An alloy according to the present description may comprise a mixture of gold and silver together forming at least 50% by mass, or 80% by mass or more, of the mechanical part. This does not preclude more than two precious metals being combined to form an alloy. According to a particular embodiment, an alloy may consist exclusively of a combination of two or more of the precious metals listed above.

According to one embodiment, an alloy according to the present invention comprises one or more of the precious metals listed above and one or more other non-precious metals such as copper, tin, aluminium, zinc, titanium or nickel.

The different materials M1, M2 can refer to different alloys based on the same precious metal. For example, the first material M1 may designate a first gold alloy and the second material M2 may designate a second gold alloy. One or both of the first M1 and second M2 materials may be selected from the following gold alloys, for example:
White gold: 75% gold, 19% copper, 6% silver,
White gold: 75% gold, 25% palladium or 25% nickel,
Red gold: 75% gold, 25% copper,
Pink gold: 75% gold, 20% copper, 5% silver,
Green gold: 75% gold, 25% silver.

All 18 ct gold alloys from 1N to 5N can be considered as different materials M1, M2 and assembled in the same piece. Other gold alloys can be considered as required. In addition, various alloys based on precious metals other than gold can be considered, such as platinum-based alloys or palladium-based alloys.

Precious metals can be used independently of each other in different amount, such as 9 ct, 12 ct, 18 ct or 24 ct, or in other amounts.

The first M1 and second M2 materials are characterized by their own melting temperatures T1, T2. For example, the melting temperature of gold at atmospheric pressure is around 1064° C. The melting temperatures of gold alloys are generally higher than this value. The melting temperature of palladium is around 1554° C., that of platinum around 1768° C., that of rubidium around 39° C., that of scandium around 1541° C., that of rhodium around 1964° C., that of iridium around 2446° C., that of ruthenium around 2333° C. and that of osmium around 3033° C.

The process according to the present description comprises a step S3 of arranging the first P1 and second P2 powders in a sintering mold 2. The first P1 and second P2 powders are arranged sequentially so as not to mix. They can each be arranged to form a powder bed, or a powder heap, or in different arrangements, such as in lines, or in geometric or random patterns. Depending on requirements, one or more of the first P1 and second P2 powders, and any additional Pi powders (see below), can be used repeatedly, for example to form several clusters, or several lines, or in several layers, alternating with other powders.

In one embodiment, the powders can be vibrated or subjected to any other operation to make them denser or more evenly distributed, if required. It is then necessary to ensure that the first P1 and second P2 powders do not mix during these operations, if they take place.

The first P1 and second P2 powders can be used in varying proportions, for example in equal quantities, so that the final mechanical part comprises as much of the first material M1 as of the second material M2, irrespective of their distribution. The M1/M2 ratio of the first M1 and second M2 materials can, for example, vary from 10/90 to 90/10 or from 20/80 to 80/20. Ratios between 30/70 and 70/30 or 40/60 and 60/40 are of course possible.

The combination of powders forms an assembly A of unmixed powders. The first P1 and second P2 powders are in contact with each other, but each remains localized at the specific points determined when they were placed in the mold 2.

The process described here does not preclude the use of powder mixtures to produce an in-situ alloy. For example, in addition to the first powder P1 and the second powder P2, a third powder consisting of a combination of the first P1 and second P2 powders, or other powders, may be added. Under these conditions, the third powder corresponds to a precious or noble metal alloy as defined in the present description.

Once the unmixed powder assembly A has been produced, it is subjected to sintering in a step S4. The sintering conditions involve a sintering temperature Tfri. They also include a sintering pressure Pfri, which may be a mechanical pressure.

The sintering temperature Tfri is determined in such a way that none of the powders in the powder assembly A melt under sintering conditions. The appropriate sintering temperature Tfri can be evaluated as a function of the sintering pressure Pfri, so as not to reach or exceed, or remain below, the melting temperatures T1 and T2 of the first M1 and second M2 materials at the sintering pressure Pfri. Preferably, the sintering temperature is determined so as to remain below the lowest of the melting temperatures T1, T2 of the first M1 and second M2 materials under sintering conditions. It is understood that the sintering temperature varies according to the first and second materials used and/or their alloys. In this case, the sintering temperature is defined in relation to the physical properties of the materials involved.

Preferably, the sintering conditions are those of flash sintering, also known as SPS (spark plasma sintering). The use of electrodes to heat the A assembly of unmixed powders enables very short heating times and preserves grain fineness.

In one embodiment, the sintering temperature Tfri is less than 2000° C., or even less than 1500° C., or even less than 1000° C. For example, the sintering temperature is between 600° C. and 1600° C.

The sintering pressure Pfri can be between 20 and 180 N/mm² or between 50 and 100 N/mm². Other pressure values may be preferred, depending on the components selected and/or the required quality of the final mechanical part.

Once sintering has been completed, a solid part B is obtained from the assembly of powders A. The solid part B is inhomogeneous and therefore locally comprises different compositions, each corresponding to the first M1 and second M2 materials used. The local compositions may therefore correspond independently of one another to pure precious metals or to specific precious metal alloys.

The solid part B, once obtained, is demoulded in a step S5, so as to recover a demoulded solid part C.

The demolded solid part C may correspond to the final component. However, it may be necessary for the demolded part C to require one or more subsequent operations to improve its quality or aesthetic appearance, or to modify the part obtained to obtain the final component 1. A rectification step S6 may, for example, be used to resize the demolded solid part C. A machining step S7 can be carried out to modify the solid part C, resulting in one or more holes, or grooves, or ridges, or any other ablation of material. Machining can be performed by any suitable technique, whether mechanical, laser, waterjet or equivalent. One or more S8 finishing steps may also be envisaged. Other post-sintering transformations can be provided as required.

Although the process is described above with two materials, this in no way precludes the use of more than two, such as three or more, in the same or similar arrangements as those already described. FIG. 2 illustrates the process with an additional material Mi, atomized into an additional powder Pi in an additional atomization step Si. The additional material or materials Mi are different from the first M1 and second M2 materials. However, they are selected from the precious or noble metals mentioned above, or their combination. The additional powder or powders Pi obtained are processed and handled under the conditions already described for the first P1 and second P2 powders. In particular, adequate provision is made to ensure that they do not mix with other powders. The additional material(s) can be selected directly in powder form. In this case, the corresponding atomization step(s) may not be necessary.

The set of first P1, second P2 powders and one or more additional Pi powders arranged separately in a mold so as to form an assembly of at least three unmixed A′ powders, is subjected to a sintering operation under the required conditions, so as to obtain a solid part B′ comprising the first M1, the second M2 and one or more additional Mi materials, combined although distinct from one another. The temperature and pressure conditions for sintering are those already mentioned for the assembly of at least two powders A. In particular, the sintering temperature Tfri is set so that none of the first M1, second M2 or additional Mi materials melt during sintering. The solid part B′ can be demolded to obtain a demolded solid part C′. One or more of the post-demolding operations S6, S7, S8 described above can be carried out, as illustrated in FIG. 3.

According to one embodiment, other materials such as pigments may be added to any of the first P1, second P2 and additional Pi powders. Such additives, if present, are preferably in quantities of less than 5% or even less than 1% by weight.

The part resulting from the process described here is thus produced by a single sintering operation, even though it comprises several materials or alloys. This process has the advantage of being simple and straightforward. In this case, it dispenses with the assembly stages of different sub-assemblies often required for this type of component. The demarcation of colors and geometric patterns also remains sharp and clear. In particular, concentration gradients at the junction of different materials are zero or limited to less than 10 micrometers or 5 micrometers, or even less than 1 micrometer. The patterns produced are directly implemented in the mass of the component. Patterns are understood here to mean any variation in color or shade, any two- or three-dimensional shape taken from the mass of the component, or any other visual and/or aesthetic or ornamental aspect. Patterns coincide with the interfaces of the component's various materials. Due to the variation in local composition, these patterns may be accompanied by local variations in mechanical properties, particularly in terms of hardness.

The present description also covers a mechanical part 1 manufactured according to the process described above. In particular, this is a metal part based on at least two precious or noble metals or their alloys, or at least three precious or noble metals or their alloys. In the context of the present description, a part based on precious or noble metals contains one or more precious or noble metals for at least half of its mass. According to an embodiment, the mechanical part comprises for 80% of its mass or more, or for 95% of its mass one or more precious or noble metals, or their alloys. The various precious or noble metals of such a part are distinct from one another. In this way, the mechanical part 1 can be characterized by different colors characteristic of the different precious or noble metals of which it is made. Patterns can also appear, such as camouflage effects or geometric patterns. Alternatively, or in addition, it can be characterized by different local mechanical properties, specific to the different precious or noble metals of which it is composed.

The distribution of the various precious or noble metals in the mechanical part is not limited. The different precious and noble metals can be distributed in superimposed layers, or in clusters within the mechanical part, or in any other arrangement determined during its manufacture. One of the precious or noble metals may remain completely hidden from view, particularly if it forms the core or inner part of the part, covered by another precious or noble metal. Nevertheless, the delimitation of the different materials within the piece remains sharp and clear. The resulting visual effects are of the highest quality.

Thus, a mechanical part 1 according to the present description comprises at least a first material M1 and a second material M2 forming an indissociable whole, e.g. monolithic or monobloc, in which the at least first M1 and second M2 materials remain distinct from one another. In addition to the first M1 and second M2 materials, the mechanical part 1 may comprise one or more other additional materials Mi, different from the first M1 and second M2 materials and also distinct from the other materials. The first M1 and second M2 materials, as well as any additional materials Mi, are selected from one of the above-mentioned precious or noble metals or their alloys.

The mechanical part 1 can be, for example, a watch component such as a gear train or any other part of a watch movement. Alternatively, the mechanical part 1 is an ornamental or decorative component. It can be, for example, a watchcase or dial or any other element visible to a user. In this respect, the mechanical part 1 benefits fully from the advantages of the process described above, which is particularly well-suited to combining different precious metals within a single part and thus producing a wide variety of aesthetic effects.

### Example 1

A first 5N 18 ct gold powder and a second 2N 18 ct gold powder are successively stacked in an SPS sintering mold. Sintering is carried out at a temperature of 800° C. and a pressure of 100 MPa, and the resulting pellet is demolded to form a watchcase. As all the materials are 18 ct, the resulting case middle is also 18 ct.

### Example 2

A first 18 ct 5N gold powder and a second 18 ct yellow gold powder are successively stacked in an SPS sintering mold. A third 950/1000 platinum powder is placed on top of the first two powders. Sintering is carried out at a temperature of 860° C. and a pressure of 130 MPa, and the resulting pellet is demolded and machined into a bezel. The part is then finished by decorating the 950/1000 platinum surface layer, which is softer than the underlying layers. The final part is not titrated.

### Example 3

A first 18 ct 5N gold powder, a second 18 ct 2N gold powder and an 18 ct grey gold powder are randomly distributed in an SPS sintering mold to form powder clusters. Sintering is carried out at a temperature of 790° C. and a pressure of 80 MPa. The resulting pellet is demolded to produce a bezel with a camouflage pattern of yellow, pink and grey. As all the materials are 18 ct, the final piece is also 18 ct.

### REFERENCE NUMBERS USED IN THE DRAWINGS

1 Mechanical part
M1 First material
M2 Second material
Mi Additional material(s)
P1 First powder
P2 Second powder
Pi Additional powder(s)
S1 Atomisation step of the first material
Si Atomisation step of the additional materials
S2 Atomisation step of the second material
S3 Step of arranging the powders in a mold
S4 Sintering step
S5 Demolding step
S6 Rectification step
S7 Machining step
S8 Finishing step

1. A process for manufacturing a watch component based on at least two precious or noble metals or alloys of precious or noble metals, remaining distinct from one another, said watch component comprising at least 50% or 80% or more, by mass of these metals and/or alloys, the method comprising:
selecting
a first material in the form of a first powder, said first material having a first melting temperature at atmospheric pressure,
a second material in the form of a second powder, said second material having a second melting temperature at atmospheric pressure,
and optionally one or more additional materials different from the first and second materials, in the form of as many corresponding additional powders,
A step S3 of arranging said materials in powder form in a mold, so as to form an assembly of at least two unmixed powders, in which said powders are in contact,
A step S4 of sintering under conditions that produce a solid part from the assembly of unmixed powders,
A step S5 of demolding said solid part to obtain a demolded part, wherein said first, second and additional materials designate said precious or noble metals or precious or noble metal alloys contained in the watch component, and the sintering is a flash or SPS type sintering, operated at a sintering temperature and a sintering pressure, said sintering temperatures and pressures being determined so that none of said materials melts.

2. Process according to claim 1, wherein said first, second and additional materials are selected from gold (Au), silver, platinum (Pt), palladium (Pd), osmium (Os) and alloys thereof.

3. Process according to claim 1, wherein said alloys comprise at least 50% by mass, or 80% or more, or even 95% by mass of a precious or noble metal or a combination of precious or noble metals.

4. Process according to claim 1, in which the powders are arranged in step S4 so as to independently form one or more alternating clusters, rows or layers.

5. Process according to claim 1, wherein one or more of said first, second and additional powders comprises one or more additives.

6. Process according to claim 1, wherein the sintering temperature is between 600° C. and 1600° C.

7. Process according to claim 1, wherein the sintering pressure is a mechanical pressure between 20 and 180 N/mm².

8. Process according to claim 1, further comprising one or more of a step S1 of atomizing said first material so as to produce said first powder, a step S2 of atomizing said second material so as to produce said second powder and a step Si of atomizing said additional materials so as to produce the corresponding powder or powders.

9. Process according to claim 1, further comprising one or more of the steps:
S6 rectifying the demolded solid part to the desired thicknesses,
S7 machining the demolded solid part,
S8 finishing the demolded solid part,
so as to obtain said watch component.

10. A metallic timepiece component comprising at least two materials selected from a first material, a second material and optionally one or more additional materials forming a monobloc assembly in which the first, second and additional materials remain distinct from one another, wherein interface of said at least two materials has a gradient of concentration providing a clear and sharp distinction of said materials, and form a pattern in the mass of said component, said materials being selected from the group of precious or noble metals and their alloys, said pattern corresponding to the interface of said materials.

11. The metallic timepiece component according to claim 10, said pattern comprising one or more of a local color variation, a local hue variation, a two-dimensional shape, a three-dimensional shape, as well as their combination.

12. The metallic timepiece component according to claims 10, wherein the gradient of concentration of said at least two materials is null or reduced to a thickness of less than 10 micrometers, or less than 5 micrometers, or less than 1 micrometer.

13. A metallic timepiece component comprising at least two materials selected from a first material, a second material and optionally one or more additional materials forming a monobloc assembly in which the first, second and additional materials remain distinct from one another, wherein interface of said at least two materials has a gradient of concentration providing a clear and sharp distinction of said materials, and form a pattern in the mass of said component, said materials being selected from the group of precious or noble metals and their alloys, said pattern corresponding to the interface of said materials, said component being obtained by the process according to claim 1.

14. The metallic timepiece component according to claim 10, said component being a decorative finishing or movement part.

15. Timepiece comprising a timepiece component according to claim 10.

16. The metallic timepiece component according to claim 11, wherein said one or more of a local color or hue variation is three-dimensional.
